(19) United States
(12) Patent Application Publication
(10) Pub. No.: US 2010/0094872 A1
(43) Pub. Date: Apr. 15, 2010

(54) METHOD AND SYSTEM FOR IDENTIFICATION OF OBJECTS

(76) Inventors: Eija Lehmuskallio, Espoo, (FI); Jouko Lehmuskallio, Espoo (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 12/593,201

(22) PCT Filed: Mar. 7, 2008
(86) PCT No.: PCT/FI2008/000039

§ 371 Date: Oct. 17, 2009

(30) Foreign Application Priority Data
Mar. 27, 2007 (FI) 20070247

(51) Int. Cl. G06F 17/30; G06K 9/62

(52) U.S. Cl. 707/737; 707/769; 382/224; 707/E17.014; 707/E17.033

(57) ABSTRACT

Objects are identified on the basis of location and one or more characteristics by a user device and a service product. The service product provides a service, with which objects can be identified. The object to be identified is positioned, the user device is connected to the service and the service fetches information on the basis of the position of the object and its characteristic(s) from a database. The fetched information is presented to the user device. The user device presents the characteristic(s) of the object to be identified by sending a picture of the object to be identified to the service product, in which picture the service product reads the characteristics of the object and conducts additional searches in the database based on the characteristics read from the picture.

### TECHNICAL FIELD

The present invention is concerned with a method and system for identification of objects, especially for identification of objects in the nature, such as plants, animals and minerals.

### BACKGROUND

People walking in the nature might want to identify different objects and phenomena in nature, such as plants, mushrooms, stones, minerals, butterflies, insects, animals and phenomena in the sky. Localization of a place is another problem often faced with when trying to figure out where you are.

Trying to figure out where you are is probably one of the oldest pastimes of people. Navigation and positioning are crucial to so many activities and yet the process has always been quite cumbersome. Along with the increasing use of mobile stations, there are nowadays methods with which positioning or localisation can be performed.

GPS is the first positioning system to offer highly precise location data for any point on the planet, in any weather. The most important application of GPS is the simple determination of a “position” or “location”.

Technically, The Global Positioning System (GPS) is a worldwide radio-navigation system formed from a constellation of 24 satellites and their ground stations. The idea behind GPS is to use satellites in space as reference points for locations on earth. GPS uses the satellites as reference points to calculate positions accurate to a matter of meters, with advanced forms of GPS even measurements better than a centimeter can be made. These days GPS is finding its way into cars, boats, planes, construction equipment, movie making gear, farm machinery, even laptop computers and all mobile stations. A GPS signal contains exact information of e.g. the position of a GSM-phone.

GPS provides two levels of service, Standard Positioning Service (SPS) and the Precise Positioning Service (PPS). SPS is a positioning and timing service, which will be available to all GPS users on a continuous, worldwide basis with no direct charge. SPS provides a predictable positioning accuracy of 100 m (95%) horizontally and 156 m (95%) vertically and time transfer accuracy to UTC within 340 nanoseconds (95%). PPS is a highly accurate military positioning, velocity and timing service, which will be available on a continuous, worldwide basis to users authorized by the U.S.

To make use of GPS, a GPS receiver is needed. Many different types of receivers exist and have become less and less expensive in recent years. A GPS receiver “listens” for the signals that are broadcast from the satellites of the United States Department of Defense (DOD) Global Positioning System. Each satellite broadcasts information that contains the position of all satellites in the constellation. GPS receivers use the signals in order to determine the position of the satellites.

Users need to transform position data into a plane (flat) coordinate system, either to merge them with another data set, to plot a map of the GPS results, or to perform further calculations for such parameters as area, distance or direction. GPS receivers can usually report position information in more than one format. The most common format is latitude and longitude.

Together, the Global Positioning System and GPS receivers provide the means for determining position anywhere on the earth. A GPS configuration comprises a GPS receiver and antenna, and software to interface differentially corrected GPS data from the receiver to other electronic equipment.

The identification of objects and phenomena in nature is usually based on knowledge or by using books or sites on the internet for finding the desired information. When walking in nature it is, however, not practical to carry heavy books or computers, and even if a mobile station with access to internet would be available, most objects can not be identified very quickly, if even at all, due to the extensive amount of alternatives in big databases. The identification of different objects in these databases is based on photographs (and sometimes high resolution scanning) of the objects to be identified.

In the earlier application FI-20050492 of the applicants, corresponding to WO publication 2006/120286, there has been presented a method and a system, wherein the objects can be identified on the basis of localization and one or more characteristics by means of a user device and a service product. The object to be identified is positioned and the position of the object is notified to the service, to which the user device is connected. The user of the user device selects one or more property of the object presented by the service. One or more messages, which contain the position of the object and the selected properties are then sent from the user device to the service. The service fetches information on the basis of the position of the object and the selected characteristic or characteristics from a database. The fetched information is presented for the user device in the form of one or more alternative objects to be identified.

For the final identification of the object, several messages are sometime needed between the user and the service product, wherein the service product sends selectable properties of the object to the user and the user informs those properties to the service product, which match the object to be identified from the presented properties.

Now the applicants have invented a still better way to identify the objects, with which the number of messages between the user and the service product can be decreased.

### SUMMARY OF THE INVENTION

The invention is based on a method and a system, wherein objects can be identified on the basis of location and one or more characteristics by means of a user device and service product. The service product provides a service, with which objects can be identified. In the method, the object to be identified is positioned, the user device is connected to said service and the service fetches information on the basis of the position of the object and its characteristic(s) from a database. The fetched information is presented for the user device in the form of one or more alternatives. The invention is mainly characterized in that the user device presents the characteristic(s) of the object to be identified by sending a picture of the object to be identified to the service product, in which picture the service product reads the characteristics of the object on the basis of which the fetch from the database takes place.

The system is mainly characterized in that, the user device has means for taking a picture of the object to be identified and for sending it to the service product and the service product has means for pattern recognition and for comparison to alternatives in a database.

Different embodiments of the invention are presented in the subclaims.

In one such embodiment, the service product reads characteristics of the object form the picture on the basis of the form, the colour and/or the size of the object. The service product can get information both of that the user has selected the right characteristics from the alternatives presented by the service product and of that the service product has read characteristics of the object to be identified from the picture sent to it. In the latter possibility, the service product excludes such alternatives from the alternatives presented which do not match with those characteristics that it has been able to read out from the picture. Such characteristics are e.g. the number of different parts, the size (as well as the mutual proportions of the parts), the colour, the number of petals etc.

The user device is preferably a mobile station, whereby the localization of the object to be identified is performed by positioning the mobile station, whereby the information of the position in the stage corresponds to the information given by the positioning system in the mobile station. Said information can be notified automatically by means of GPS in separate messages or in combined messages and in optional steps. The localization can also be performed manually by informing the position of the object found to the service product.

The picture to be sent to the service product is most practically taken with the same mobile station as the one with which it is sent to the service product, but it can also be a picture taken with e.g. a separate digital camera or it can be a scanned picture.

Preferably, the database consists of local databases, an object menu for each local database and submenus on different levels for the object menu. It is practical to have a local database for different regions in a country. The objects to be identified are classified in the database on the basis of different characteristics in a hierarchic system by means of submenus. The submenus contain images, text or photographs of the objects and the images, text or photographs in the submenus describe the objects by pointing out certain characteristics.

The invention is primarily meant for identification of objects in the nature, such as plants, mushrooms, stones, minerals, butterflies, insects, animals and phenomena in the sky. It can, however, be extended to other suitable things, e.g. to identification of stars, planets, or different types of clouds, auroras etc, weather forecasts, other future forecasts, such as possible development of the local nature in question, and also for localization of sights, cities, villages etc.

When e.g. the service is used for identification of unknown plant species, the hierarchic structure of the database enables a very user-friendly interface.

As the user already has informed the location of the plant, either by means of the position of the mobile station or by sending the location information manually, the system excludes all plants not being within the region of localization and which do not exist at that time in the area in question. In this way, the identification is faster and the information that has to be sent over-the-air is less extensive.

If the system does not immediately find objects to be suggested on the basis of the picture and the position, the service product may ask additional information about the object. Then, the user might see symbols (or descriptions, images or photographs), which describe characteristics of the species, which are successively given or then such suggestion(s) are chosen which in the best possible way correspond(s) to the species tried to be identified. When it is question about plants in the nature, these symbols or the like (in the submenu) can e.g. describe the colour of the corolla, the form of the leaves or leaflets, the diameter of the stem or the shaft etc.

Sometimes the identification is easier, whereby the mere picture or localisation information, a single selection from the characteristics, is enough in order to perform the identification. Sometimes, however, further characteristics are presented for the mobile station in more steps in order to be identified and sent to the service product before the final result or alternative(s) are presented for the mobile station. After every new given description, the service presents the number of possible species there still are and when the user feels that the amount of alternatives is reasonable he asks for and gets the pictures, names and description of each species the service has accepted.

The results can also be shown without asking in some embodiments and especially if there is only one alternative to present. Each species can have several pictures and details for making the identification more exact. In case of a possible rarity, which the service informs about, the user can store the position in a memory of his device for the future.

The presented pictures, which describe characteristics and are stored in the database of the service product, can be made very detailed by a special method invented by the inventors. In this method, the picture of e.g. a plant to be identified later by the user is made by first preparing the plant in a special way. The fresh plant is pressed very carefully by avoiding destruction of any parts of the plant and then scanned in a good quality scanner and the scanned picture is stored in the database of the service product. In the service, any detail of the pictures presented can be zoomed for a better look at e.g. hairs (if they are e.g. curved or glandular) occurring in the plant in order to be compared to the living object at site by the user.

The presentation of the different characteristics and results and the service generally can of course be performed in a lot of different ways and is also a question of design. In addition to the alternatives of presentation of the characteristics of e.g. plants, it can especially be mentioned that e.g. the service language can be selected among many possibilities and the names of plants, bugs, butterflies etc are preferably also in Latin.

It is understandable that there are given requirements set to the user device so that all possibilities of the service could be made use of. The best possible benefits are achieved when the user device supports e.g. WAP or is a 3G device and have a color screen big enough in size. The bigger the screen, the better can all details be presented. The characteristics to be selected and the final results can, however, be presented for the user in different formats taking the capabilities of the user device into consideration. Preferably, the message containing the selected alternatives sent to the service provider also comprises information of terminal capabilities. The service then sends the information to the mobile station in a suitable form on the basis of the terminal capabilities.

Usually, the use of the invention takes place via internet and the user device is in connection with the service provider offering said service through Internet.

The invention is, however, especially meant for use in connection with mobile stations and other wireless terminals as user device.

When said user device is a mobile station, the positioning of an object to be identified can advantageously be performed by positioning the mobile station. When the service gets the location information by a positioning system in the mobile station, the user does not have to enter the position, instead the service gets the position of the object (which corresponds to the position of the mobile station) directly. The mobile station is preferably a GSM phone or other wireless terminal supporting GPS.

The service product can be in the user device or the service product is requested from a service provider via a public network such as internet.

The invention is now described by means of some advantageous embodiments and examples, the details of which the invention is not restricted to.

### FIGURES

FIG. 1 is an architecture view of an environment in which the invention can be implemented

FIG. 2 is a signal diagram of an embodiment of the method of the invention

### DETAILED DESCRIPTION

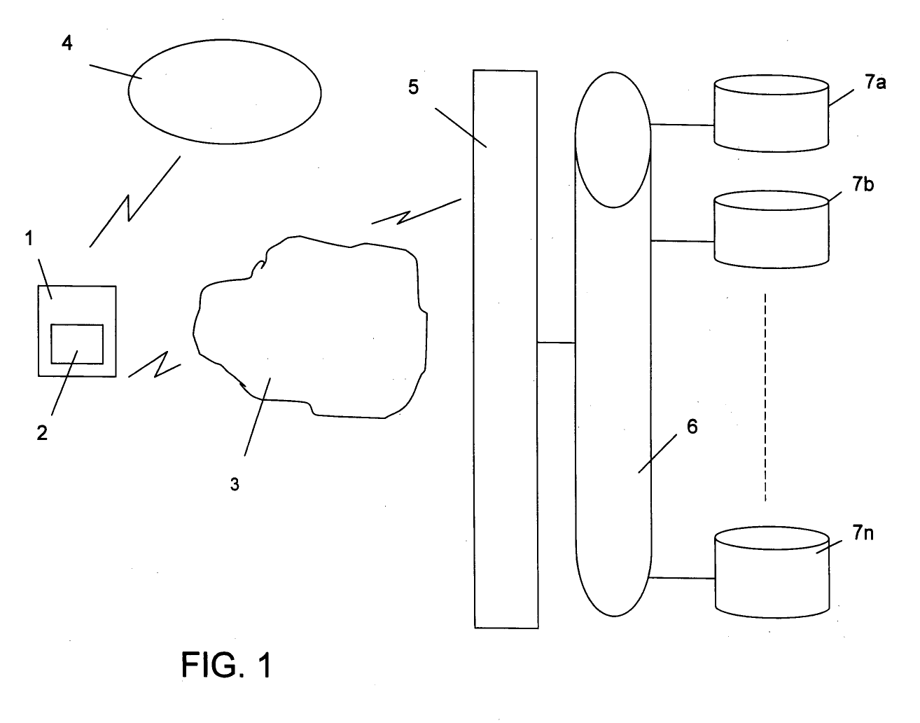

FIG. 1 is an architecture view of an environment in which the invention can be implemented. In this example, the user device is a mobile station 1 having a GPS receiver 2, with which the mobile station can be positioned via a satellite system 4. The mobile station 1 is preferably a GSM phone with access to a public network 3, such as the internet, via e.g. a WAP interface or the like. The mobile station communicates via the public network with a service provider 5 holding a service with a database 6. The database in turn is connected to local databases 7a-7n.

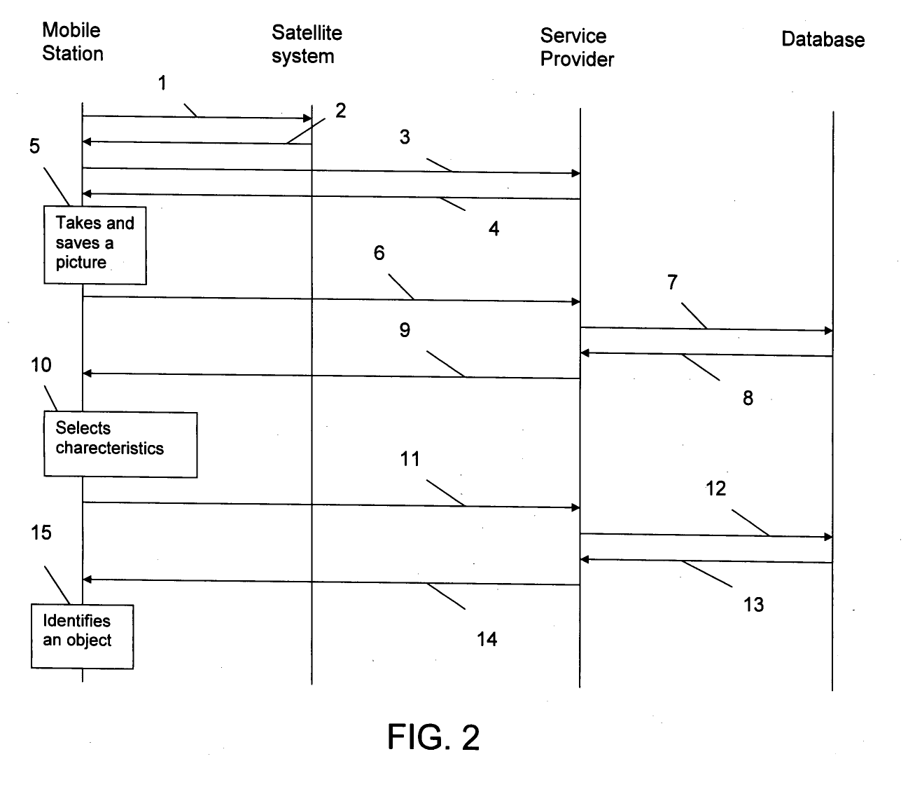

FIG. 2 is a signal diagram of an embodiment of the method of the invention. It is assumed that a user is walking in nature carrying a mobile phone with access to internet. Next, the user finds a plant he does not recognize and therefore would like to identify. As the user has a GPS receiver in the phone, the phone can be positioned by means of signals 1 and 2 through a GPS satellite system.

In signals 3 and 4, the user requests for respective gets a service from the service provider by means of which the plant found can be identified.

First, the service can be presented for the user in form of a menu of alternatives to be identified, after which the user has to select whether he wants to identify e.g. a plant, an animal, an insect, or a stone etc.,

The database can e.g. have a main menu comprising objects to be identified, such as e.g. Plants, Animals, Insects, Stones, Sights etc. according to which the service provider has designed the product.

If the user for instance selects a plant, the presentation for the user made by some of the local databases is based on the position of the plant and the season.

The service program can select a colour, a terrain (form where the plant was found), and the model of the plant found from the local database. In an embodiment, wherein the user has a wireless terminal using the GPS system, the service product gets the information directly from the position of the object and therefore sometimes also the type of terrain, where the plant was found or the area, wherein it appears.

When some alternative has been selected for identification, the description of the object can be fetched from a submenu and thereafter a more detailed description from another submenu, which is still lower in the hierarchy.

A more detailed description has nee presented in the earlier patent application of the applicant FI-20050492 corresponding to WO publication 2006/120286.

Alternatives are presented for the user on the basis of the selections from a submenu. If the user wants, he can select more properties from different submenus, if the service ahs not found the final alternative or if the user is of the opinion that there are too many alternatives on the basis of the first selection.

Next, the user takes a picture from the object to be identified with his mobile station and stores it in step 5.

The message, which then is sent to the service provider in step 6, contains the position of the object, which position information has been received from a GPS receiver in the telephone. In alternative, said information is sent to the service in separate messages in optional steps of the method or even with signal 3. If the telephone does not have any GPS receiver, the user ahs to put in the position manually either by clicking on alternatives presented by the product or by giving coordinates.

The mobile station sends the picture taken of the object to the service provider together with message 6 or possible as a separate message.

The message sent to the service provider (signal 3 or 6) possibly also contains information of the properties selected and optionally about the capabilities of the terminal.

The service product has means (software) to combine the picture and possibly also the time information and it can connect to the right local database by means of the information in the message of signal 6. The software can read information on the absis of the form of the object from the picture (by pattern recognition), its size and e.g. its colour.

When the service product makes use of picture information, it compares the picture to alternatives in the database and it can in this way eliminate e.g. such alternatives form the existing alternatives, which do not fit with information that can be read from the picture. Such information can e.g. be the number of petals, the form of the flower, the form of the leaf, the colour, the size etc.

Information about possible plant alternatives matching the characteristics given is fetched from the local database in question with signals 7 and 8. The service product preferably also takes the season into consideration (time information) when fetching the information.

Preferably, the service product also has means to take the terminal capabilities of the user device into consideration in order to present the results and characteristics to the user in an optional format.

The result of this first search is sent to the user device in signal 9.

It is very probable that it is possible to present a single alternative for the user already in this stage, which alternative match the properties sent with signal 6, whereby the user already recognizes the plant. If so, the next step after step 9 is step 15.

If the properties given with signal 6 match with several plants, many alternatives can be presented for the user, from which the user already in this stage can fins the right alternative.

In step 10, the user can, however continue to select more detailed characteristics for the plant found and request for alternatives matching the new characteristics in step 11 to narrow the results to less alternatives if there was more than one possible alternative.

Or then the service presents characteristics of such an object e.g. in the form of symbols, whereby the user can select (by clicking) one or several of those symbols that best correspond to the characteristics that describe the plant found.

Thus, the results show one or more possible alternative image or images having the characteristics selected by the user and which occur at the season in question. The result might also present other characteristics to be selected in order to improve the search results.

Possible plant alternatives matching the new characteristics given are again fetched from the local database in question with signals 12 and 13 and the results are presented for the user with signal 14, if these steps are necessary.

In this example, it is now assumed that the user can identify the plant in step 15 either because there was only one alternative presented or then the user could identify the plant by means of the alternatives left.

The user might give more characteristics several times to the service product before the right alternative for identification occurs.

1. A method for identification of objects based on one or several characteristics of the objects by using a user device and a service product, comprising:
the service product providing a service with which objects are identifiable,
positioning an object to be identified,
connecting the user device to the service of the service product,
the service product fetching information from a database based on the position and characteristic(s) of the object to be identified presenting the fetched information in a form of one or more possibly matching objects to the user device based on a first search in the database
the user device presenting additional characteristic(s) of the object to be identified by sending a picture of the object, and
the service product reading the additional characteristics of the object from the picture, and
the service product conducting a second search in the database based on the additional characteristics read from the picture.

2. The method of claim 1 wherein the service product reads the additional characteristics of the object from the picture based on form, color and/or size of different parts of the object, the service product compares the read characteristics to characteristics of the possibly matching objects and eliminates such possibly matching objects that do not match the characteristics read from the picture.

3. The method of claim 1 wherein user device is a mobile station, the positioning of the object to be identified is performed by positioning the mobile station so that the position of the object to be identified corresponds to information given by a positioning system in the mobile station.

4. The method of claim 1 wherein the positioning of the object to be identified is performed by manually informing the service product about the position of the object to be identified.

5. The method of claim 2 wherein the picture sent to the service product is taken by the mobile station.

6. The method of claim 1 wherein the picture sent to the service product is taken with a digital camera or the picture is a scanned picture.

7. The method of claim 2 wherein the service product fetches the information based on the characteristic(s) read from the picture, the position of the object, selected characteristic(s) and time information.

8. The method of claim 1 wherein the method further comprises the steps of presenting further characteristics to the user device for identification and sending the further characteristics to the service product before a final result or final alternatives are presented to the user.

9. The method of claim 1 wherein the service product is in the user device.

10. The method of claim 1 wherein the service product is requested from a service provider via a public network.

11. The method of claim 1 wherein a message from the user device further comprises information of terminal capabilities of the user device.

12. The method of claim 11 wherein the service product presents the information to the user device in a form based on the terminal capabilities of the user device.

13. A system for an identification of objects based on position and one or more properties, comprising:
a user device and a service product, the service product providing a service for the identification of objects,
the user device having means for establishing a connection to the service product and a positioning system,
a service having a database with objects classified based on position and/or characteristic(s) of the objects in the database,
the user device having means for taking a picture of objects to be identified and for sending the picture to the service product, and
the service product having means for pattern recognition of the picture and for comparing the picture to the objects in the database.

14. The system of claim 13 wherein the user device is a mobile station and further comprises a positioning system.

15. The system of claim 14 wherein the mobile station is a GSM phone or other wireless terminal.

16. The system of claim 13 wherein the service product is in the user device.

17. The system of claim 13 wherein the system further comprises a service provider having the service product.

18. The system of claim 17 wherein the user device is in connection with the service provider through Internet.

19. The system of claim 13 wherein the database consists of local databases, an object menu for each local database and submenus on different levels for the object menu.

20. The system of claim 19 wherein the system has local databases for different regions in a country.

21. The system of claim 13 wherein the objects to be identified are classified in the database based on different characteristics in a hierarchic system by using submenus.

22. The system of claim 20 wherein the submenus contain images, text or photographs of the objects in the database.
